(19) United States
(12) Patent Application Publication
(10) Pub. No.: US 2005/0177412 A1
(43) Pub. Date: Aug. 11, 2005

(54) Automobile sales simulator

(75) Inventor: Leroy P. Kemp JR., Forest Lake, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(73) Assignee: Hire the Winners, LLC

(21) Appl. No.: 10/774,564

(22) Filed: Feb. 9, 2004

(51) Int. Cl. G06F 17/60

(52) U.S. Cl. 705/10; 705/1; 705/9

(57) ABSTRACT

The present invention provides an interactive audiovisual assessment test for evaluating the aptitude of a test candidate for success in automobile sales. The system and method includes a series of interactive video clips to which a candidate must select a response, which prompts a consequent interrelated video clip. Upon completion of the test, the candidate receives an evaluation output. Additionally, the evaluation output may be forwarded to an interested third party that has registered for access to the assessment test.

### BACKGROUND OF THE INVENTION

1. Field of the Invention

The present invention relates generally to the field of pre-employment screening and post-employment training tests. More specifically, the present invention relates to an interactive video based test for automobile sales candidates.

2. Background of the prior art

One of the most important keys to a successful business is hiring the right employees. Hiring the wrong candidate can cost an employer money, time and business. For this reason, employers must carefully assess and evaluate potential job candidates as efficiently and effectively as possible when making a hiring decision.

Historically, the hiring process involves the candidate submitting a resume for review by a potential employer. The employer then performs an interview with the candidate, and a background and/or reference check of the candidate.

Some employers require candidates to take a written assessment test. These assessment tests may measure various applicable personality and cognitive traits of the candidate. The results of these tests can assist an employer in making a hiring decision.

In some industries employers have begun using videos for training and assessment programs, such as by playing a video clip of a particular situation and asking the candidate to provide feedback or to respond to the situation given in the video clip.

The automobile sales industry has a particularly high employee turnover rate. Much of this is due to the fact that salespeople are paid on commission. Also, a successful salesperson must have an array of interpersonal, cognitive and negotiation skills in addition to other related abilities.

The prevailing hiring practice in the automobile retail industry is to hire a number of sales people with the hopes that one or two will work out. It is not uncommon for an automobile dealership to have an employee turnover rate of over 40% in a given year.

### SUMMARY OF THE INVENTION

The present invention provides an assessment instrument designed to measure the critical competencies associated with the success of a salesperson working in an automobile dealership using a series of interactive audiovisual simulations to test and evaluate a job candidate. The critical competencies measured by this assessment instrument include sales skill, personality traits, cognitive ability and job suitability. The assessment includes a video simulation closely constructed and modeled around commonly encountered customer types and sales situations relating to the automobile sales industry. The assessment can be used for recruitment of new salespersons, selection of salespersons, and development and training of current salespersons.

The results from the assessment may be in narrative and/or numerical format. The results may further be broken down into subcategories. For example, the audiovisual simulation selections made by the user may be used to measure a candidates skill in building rapport, managing the sales process, listening skills, and closing the sale.

The system used to provide the assessment includes a server having a battery of assessment tests and including a series of interactive audiovisual simulations. A first computer is able to access the server, allowing a subscriber such as an automobile dealership in search of job candidates to register with the server. Registering with the server is required in order to allow the server to be accessed remotely by other computers. A candidate or employee may then access the server by a remote computer for taking the assessment test. The server records inputs from the remote computer and prepares an output report assessing the aptitude of each candidate for success in automobile sales. The server may then forward the output report to the subscriber.

### BRIEF DESCRIPTION OF THE DRAWINGS

FIG. 1 is an embodiment of a system in accordance with the present invention.

FIG. 2 is a flow chart of a method of using the present invention.

FIG. 3 is another flow chart of the method of using the present invention.

FIG. 4 is a detailed view of the flow chart from FIG. 3.

FIG. 5 is a detailed view of the flow chart from FIG. 4.

### DETAILED DESCRIPTION OF THE PREFERRED EMBODIMENTS

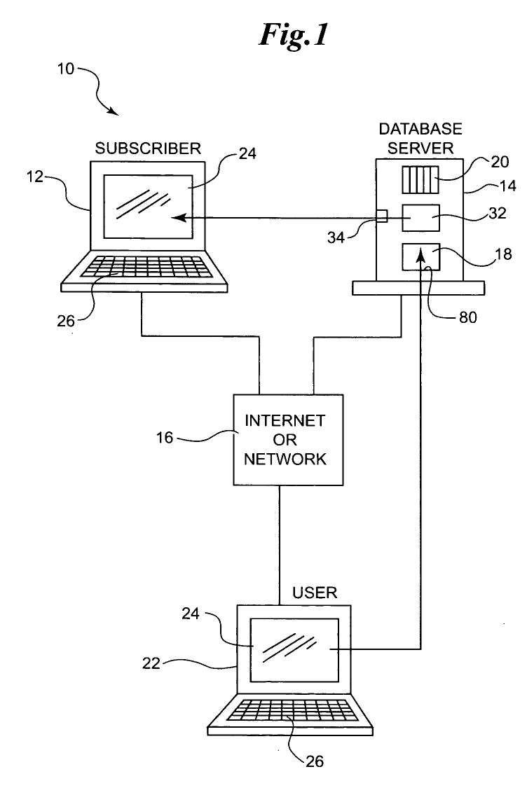

FIG. 1 illustrates an interactive system 10 for allowing employers in the automobile sales industry to assess the qualifications of automobile sales candidates and employees. A first computer system 12 is shown interfacing with a server 14 or database. The first computer system 12 is accessible by an employer to communicate with the server 14, such as over the internet or over a network 16. The server 14 has a battery of tests 18 contained therein. Included in this battery of tests 18 is a series of interrelated audiovisual simulations 20.

The first computer 12 can be used to register with the server 14, to allow a remote computer 22 to access the server 14 such that a user of the remote computer 22 will be allowed to take an assessment test 18 located on the server 14.

The remote computer 22 has a display monitor 24 for viewing textual questions and audiovisual simulations 20. An input keyboard 26 allows the user to respond and interact with the audiovisual simulations 20 and test questions 60. Each selection 28 made by the user will be recorded by the database 14 such that, upon completion of the assessment test 18, an output report 32 is created assessing the qualifications of the user for suitability in automobile sales.

Once the test 18 has been completed, the database 14 stores the test results and the output report 32. A notification 34 is sent to the user of the first computer 12 notifying him or her that a test has been completed. The output report 32 may also be forwarded to the first computer 12.

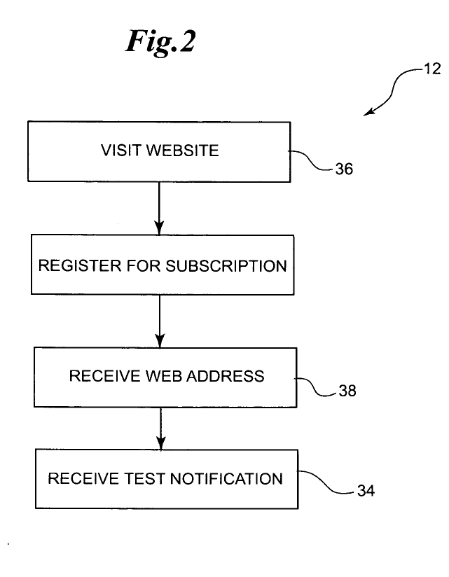

FIG. 2 is a flow diagram of the process that an employer or other such interested third party will undertake in accordance with the present invention. An employer seeking qualified candidates or seeking to train employees in automobile sales may visit a website 36 that is connected to the assessment test server 14. The third party may then interface with the website 36 to register for a subscription to the assessment test server 14. Registration may include providing contact information, payment, information regarding the third party's place of business and the like. Once registered, the third party becomes a subscriber. The subscriber will be assigned a unique website address 38 or URL that is accessible by remote computers 22.

The subscriber may advertise or communicate this web address 38 to candidates and/or employees. Candidates and/or employees may then access this web address 38 remotely to take the assessment test 18. The subscriber will receive forwarded information 34 from the server 14 such as the results of a completed assessment test 32, or that an assessment test has been completed, or that the web page has been accessed. The subscriber can elect different options relating to the type of information that the subscriber would like to have forwarded. Once the subscriber has received this forwarded information 34, the subscriber can contact the candidates or employees for follow-up, such as for an interview or for training and job improvement.

Any employer or other such third party interested in finding qualified automobile sales candidates can visit the server website 36 and subscribe to this lead generation service. When the subscription expires the URL 38 will no longer be accessible either by the subscriber or by the remote computer 22.

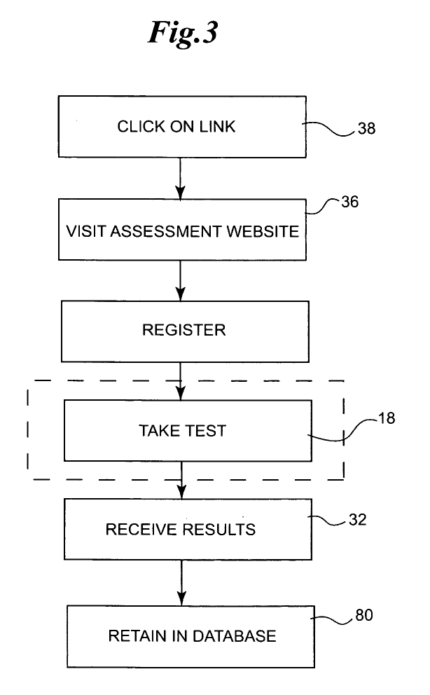

FIG. 3 illustrates a flow-chart diagram of the process that a candidate or employee may follow in accordance with the present invention. A candidate may click on the link 38 to the website or may directly visit the website to take an assessment test 18, for evaluating the potential aptitude of the candidate for automobile sales. Upon visiting the web site 38, the candidate may enter personal information such as contact information, employment history, driving history and the like. The candidate may also be asked to pay a fee for registering to take the test. Once registered, the candidate will begin taking the test. The test may include a battery of assessments 18 relating to the traits that are required for success in automobile sales.

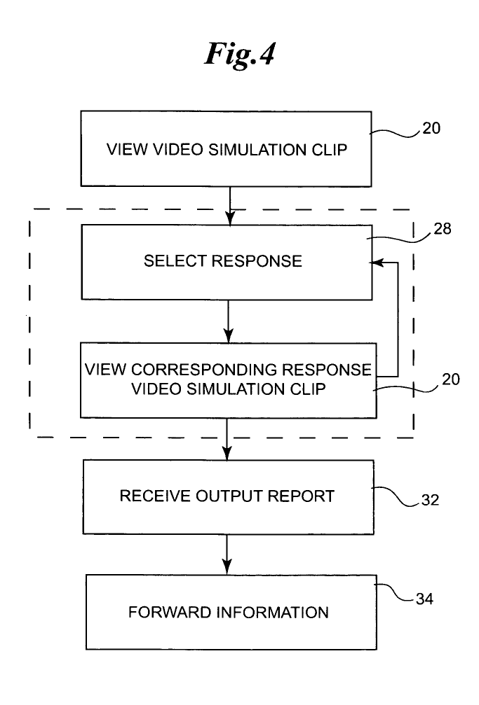

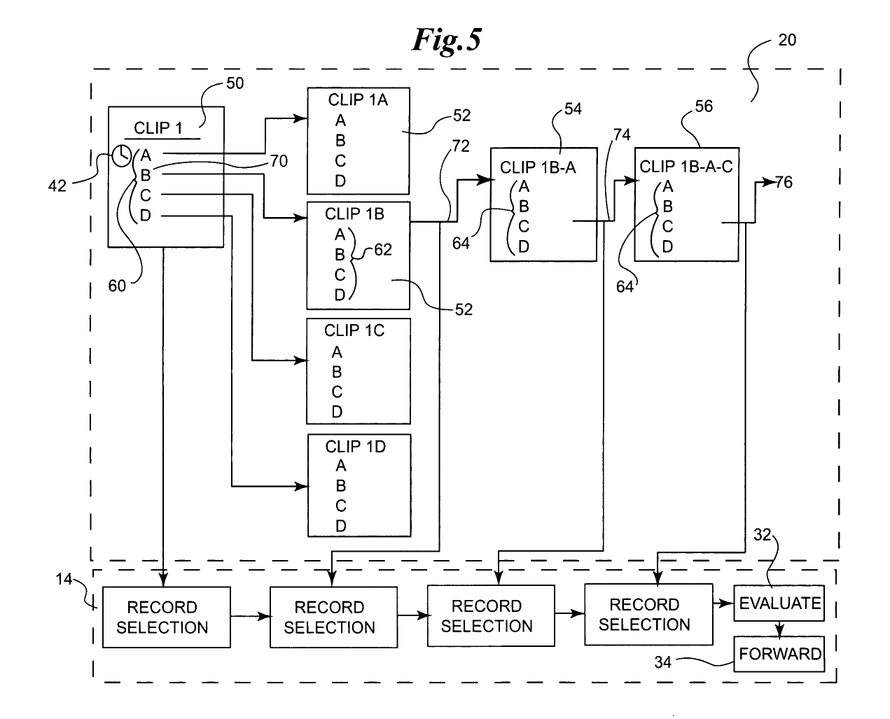

FIGS. 4 and 5 illustrate the interactive video simulation clips 20 used for assessing the skills of the user. At least a portion of the test will involve a series of interactive video clips 20 that display an audiovisual representation of situations that may arise in the course of an automobile sales, such as events relating to getting the attention of a customer and sales negotiations. Upon viewing a video clip 20, the candidate will be prompted with a plurality of possible responses 60. The candidate must make a selection 28 from these responses 60. From the selection 28, a corresponding video clip 20 will be displayed showing the consequences of the selection 28 made by the candidate. Likewise, a new set of responses 60 will be made available from which the candidate must make another selection 28, leading to yet another corresponding video clip 20. The video clips 20 may have a timer 42 such that the candidate must make a selection within a predetermine amount of time in response to the video clip 20.

Upon completion of the aptitude test 18 an assessment report 32 will be provided, based upon the selections 28 made by the candidate. For example, the report 32 may consider the selections made during the interactive portion of the test and weigh them proportionately with the other portions of the test that were used to test other personality traits. The report 32, based upon this test 18, will provide a numeric and/or narrative evaluation of the candidate and his or her potential for success in automobile sales. Likewise, this test 18 may be provided to current employees working in automobile sales as a method for teaching, training and evaluating such employees.

Once a candidate has completed the test 18, the report 32 and/or selections 28 are stored in the server 14. Also, a forwarding system 34 may notify the subscriber that the candidate has completed the test. In such case, the subscriber may be automatically billed a fee by the server for the candidate's use of the test service.

FIG. 5 provides a more detailed view of the interrelated video simulations. A first audiovisual clip 50 may be accessed from the server 14 and displayed on the display unit 24. Upon completion of the audiovisual clip 50, the user is prompted with a series of multiple choice responses 60. The input device 26 is used to make a selection 70 of one of the responses 60. Upon selection, an audiovisual clip 52 corresponding to the selection 70 is accessed from the database 14. The audiovisual 52 will again display a series of possible responses 62 based upon the simulation 52. The user makes yet another selection 72 from this new set of possible responses 62, which causes the server 14 to access the corresponding new video clip 54 from the server 14.

A database 14 on the server records the selections 70, 72, 74 of the user such that upon completion of the test 18, the database record 80 is used to provide an output report 32 based on the user's selections 70, 72, 74. The output report 32 will provide a numeric and/or narrative assessment of the user's aptitude and/or potential for success in automobile sales based on the selections made in response to the audiovisual simulations.

Upon completion of the test, the output report 32 may be maintained on the database 14, but also may be forwarded to the subscriber or interested third party by a forwarding system 34.

It is contemplated that the present invention may be used for other types of sales such as real estate or retail sales and the like. Also, the present invention may be used such as for training in non-sales related areas by providing video clips relating to a particular position or skill set.

1. An interactive system for testing a user's aptitude for automobile sales, said interactive system comprising:
a) a database of audiovisual simulations;
b) a display device for displaying said audiovisual simulations;
c) an input device for making selections in response to said audiovisual simulations;
d) an assessment output created from said selections; and
e) a forwarding service for sending said assessment output to a third party.

2. The interactive system according to claim 1 wherein said database is accessible by a first computer.

3. The interactive system according to claim 2 wherein said first computer is able to register with said database.

4. The interactive system according to claim 3 wherein a remote computer is able to access said database.

5. The interactive system according to claim 1 wherein said interactive system further comprises a first computer.

6. The interactive system according to claim 5 wherein said interactive system further comprises a remote computer.

7. The interactive system according to claim 6 wherein said assessment output is forwarded by said forwarding service to said first computer

8. The interactive system according to claim 6 wherein said assessment output is forwarded by said forwarding service to said remote computer.

9. A method for assessing skills relating to automobile sales, said method comprising the steps of:
a) displaying a first interactive audiovisual simulation relating to automobile sales;
b) displaying a plurality of potential responses to said first interactive audiovisual simulation;
c) displaying a second interactive audiovisual simulation corresponding to a selection from said plurality of potential responses; and
d) providing an aptitude analysis based upon said selection.

10. The method according to claim 9 wherein said aptitude analysis is forwarded to a third party.

11. A method for finding a qualified job candidate, said method comprising the steps of:
a) receiving inputs from a subscriber;
b) receiving a series of selections in response to audiovisual simulations from a job candidate;
c) creating an assessment based upon said series of selections received from said job candidate; and
d) sending said assessment to said subscriber in accordance with said inputs of said subscriber.

12. The method according to claim 11 wherein said inputs are received by a server from a first computer.

13. The method according to claim 12 wherein said selections are received by said server from a remote computer.

14. The method according to claim 13 wherein said assessment is sent from said server to said first computer.
